(19) United States
(12) Patent Application Publication
(10) Pub. No.: US 2018/0373517 A1
(43) Pub. Date: Dec. 27, 2018

(54) SYSTEMS, METHODS, AND APPARATUSES FOR DOCKER IMAGE DOWNLOADING

(71) Applicant: Alibaba Group Holding Limited, Grand Cayman (KY)

(72) Inventor: Zuozheng HU, Hangzhou (CN)

(21) Appl. No.: 15/994,361

(22) Filed: May 31, 2018

(30) Foreign Application Priority Data
Jun. 21, 2017 (CN) 201710475273.5

(51) Int. Cl. G06F 8/60; H04L 29/08

(52) U.S. Cl. CPC G06F 8/60; H04L 67/2842; H04L 67/104

(57) ABSTRACT

The disclosure provides methods, apparatuses, and systems for downloading Docker images using a P2P distribution system. In one embodiment, a method comprises receiving, by a supernode from a client device, a download request for a layer of a container image file, the supernode selected from a supernode list comprising a plurality of supernodes; generating, by the supernode, slice information of each slice of the layer; and transmitting, by the supernode, the slice information and at least one target node to the client device, the transmitting of the slice information and the target node causing the client device to initiate a download of slices from the supernode to the at least one target node. By means of embodiments of the disclosure, the efficiency and stability of Docker image downloading can be improved.

### CROSS-REFERENCE TO RELATED APPLICATIONS

This application claims the benefit of priority of Chinese Application No. 201710475273.5, titled “SYSTEMS, METHODS AND APPARATUSES FOR DOCKER IMAGE DOWNLOADING AND PREHEATING,” filed on Jun. 21, 2017, which is hereby incorporated by reference in its entirety.

### BACKGROUND

### Technical Field

The disclosure relates to the field of Docker image technologies, and in particular, to systems, methods, and apparatuses for downloading Docker images, systems, methods, and apparatuses for downloading a Docker image ahead of schedule, and a peer-to-peer (P2P) distribution system.

### Description of the Related Art

Docker®, by Docker, Inc. of San Francisco, Calif., is an open-source application container engine that allows application developers to package applications and dependent packages into a portable container comprising one or more layers. Application developers then deploy the portable container to any machine (i.e., deploy the applications). Docker also provides virtualization, and containers are implemented with a sandbox mechanism and are mutually isolated. Moreover, multiple read-only image layers may form a unified view of a Docker image, and each image layer contains several files and meta-information data.

In current systems, when deploying an application using Docker to a plurality of machines, each machine (e.g., a host needing to be deployed with the application) needs to download a Docker image from a Docker repository that stores the Docker image. However, in a cross-regional, or cross-national, long-distance Docker image downloading scenario or in a large-scale image deployment, the efficiency of Docker image downloading is relatively low.

### BRIEF SUMMARY

In current systems, the efficiency of Docker image downloading is relatively low because it takes a significant time to export a Docker image from a Docker repository, to extract and compress a layer, and perform various other operations on the Docker image. This leads to low efficiency when downloading a Docker image as a whole. Each application host downloading a Docker image must be deployed with an agent service and a seed client (e.g., a client implementing the BitTorrent protocol), which in turn not only occupies excessive application host resources that leads to a low downloading efficiency, but the deployment also causes instability in the downloading process.

Given this, the disclosure provides a method for downloading Docker images and a method for downloading Docker images ahead of schedule. Each time a layer of a Docker image is saved into a Docker repository, a supernode performs an ahead of schedule downloading process on the layer and downloads the layer to local storage. The supernode may download the layer in a P2P manner during the downloading ahead of schedule process. A P2P client downloads slices of the layer from the supernode directly; and specifically, the P2P client may also download the slices in a P2P manner or download the slices from the supernode, thereby avoiding the phenomenon of low downloading efficiency and poor stability caused by a direct interaction between the P2P client and the Docker repository when the P2P client downloads the slices of the layer of the Docker image.

The present disclosure further provides a control node, supernodes, a P2P client, and a P2P distribution system for ensuring the implementation and application of the aforementioned methods in practice.

To solve the aforementioned problem, the disclosure describes a method comprising receiving, by a supernode from a client device, a download request for a layer of a container image file, the supernode selected from a supernode list comprising a plurality of supernodes; generating, by the supernode, slice information of each slice of the layer, each item of slice information comprising a slice identifier and a corresponding slice check code; and transmitting, by the supernode, the slice information and at least one target node to the client device, the transmitting of the slice information and the target node causing the client device to initiate a download of slices from the supernode and the target node.

In another embodiment, a supernode is disclosed comprising: a processor; and a storage medium for tangibly storing thereon program logic for execution by the processor, the stored program logic comprising: logic executed by the processor for receiving, from a client device, a download request for a layer of a container image file, the supernode selected from a supernode list comprising a plurality of supernodes; logic executed by the processor for generating slice information of each slice of the layer, each item of slice information comprising a slice identifier and a corresponding slice check code; and logic executed by the processor for transmitting the slice information and at least one target node to the client device, the transmitting of the slice information and the target node causing the client device to initiate a download of slices from the supernode and the target node.

In another embodiment, a method comprising: receiving, by a supernode, a download address of a layer of a container image sent by the control node; determining, by the supernode, whether the layer is cached locally according to the download address of the layer; downloading, by the supernode, the layer to a local position according to the download address of the layer if the layer is not cached locally; and generating, by the supernode, layer information of the layer, the layer information comprising an identifier and a check code of the downloaded layer.

Compared with current systems, the embodiments of the disclosure have the following advantages.

In the embodiments of the disclosure, a control node, supernodes, and a P2P client on an application host are separately deployed. When an application needs to be released to the application host, the P2P client sends a download request to the control node. The control node allocates an optimal supernode and other clients to the client, so that a Docker image is downloaded from the supernode directly, or multiple clients needing to download the same Docker image download the Docker image from each other in a P2P manner. In this way, the client does not need to directly interact with a Docker repository, which not only improves the efficiency of Docker image downloading but also accelerates the entire process of using Docker to deploy an application. The method also ensures stability in the downloading process. Moreover, the embodiments of the disclosure are completely transparent to a user in that the user only needs to execute a Docker download command on a client to pull a Docker image as usual. That is, the P2P distribution system in the embodiments of the disclosure can be directly used to download the Docker image to achieve the effect of accelerating downloading. Therefore, the embodiments of the disclosure can solve not only the problem concerning the efficiency of large-scale image distribution; further, the embodiments can also solve, to a large extent, the problem that long-distance image downloading is slow or even fails due to timeout.

Additionally, in the embodiments of the disclosure, each time a layer of a Docker image is saved into a Docker repository, the supernode triggers a downloading ahead of schedule procedure. First, the supernode separately synchronizes each layer of the Docker image from the Docker repository to the local storage. After synchronization, a client downloads the Docker image from the supernode, so that the supernode can directly provide the Docker image or trigger other clients to provide the Docker image, thereby improving the efficiency of Docker image downloading. Further, even if the supernode does not save a Docker image needing to be downloaded by the client, the Docker image can be downloaded from the Docker repository in real time and provided to the client, to avoid a direct interaction between the client and the Docker repository and ensure the stability of Docker image downloading.

Certainly, any product for implementing the disclosure does not necessarily need to achieve all the above-described advantages at the same time.

### BRIEF DESCRIPTION OF THE DRAWINGS

To illustrate the technical solutions in the embodiments of the disclosure more clearly, the drawings required for describing the embodiments will be introduced briefly below. The drawings described below are merely some embodiments of the disclosure, and those of ordinary skill in the art can also obtain other drawings according to these drawings without making creative efforts.

FIG. 1 is a block diagram illustrating an exemplary scenario in actual application according to some embodiments of the disclosure.

FIG. 2 is a swimlane diagram of a P2P downloading procedure of a P2P distribution system according to some embodiments of the disclosure.

FIG. 3 is a flow diagram illustrating a method of downloading a Docker image ahead of schedule according to some embodiments of the disclosure.

FIG. 4 is a flow diagram illustrating method of downloading a Docker image according to some embodiments of the disclosure.

FIG. 5 is a functional block diagram illustrating an exemplary structure of a supernode according to some embodiments of the disclosure.

### DETAILED DESCRIPTION OF THE EMBODIMENTS

The technical solutions in the embodiments of the disclosure will be described clearly and completely below with reference to the drawings in the embodiments of the disclosure. The described embodiments are merely some, rather than all the embodiments of the disclosure. Based on the embodiments in the disclosure, all other embodiments obtained by those of ordinary skill in the art without making creative efforts shall fall within the scope of the disclosure.

### Terms

Docker: an open-source application container engine provided by Docker, Inc. of San Francisco, Calif., which allows developers to package their applications and dependent packages into a portable container and then deploy the container onto any machine, at the same time achieving virtualization, where containers are deployed with a sandbox mechanism and are mutually isolated.

Docker image: a unified image formed by multiple read-only image layers, each layer containing several files and meta-information data.

Docker repository: a place for storing image files in a centralized manner, where images can be pushed into or pulled from the Docker repository.

Docker registry: a manager managing the Docker repository, including handling queries for a Docker image or acquiring a download address of the Docker image.

P2P distribution technology: a peer-to-peer network information interaction technology, where each client can download files and meanwhile upload files to other clients to share resources among one another.

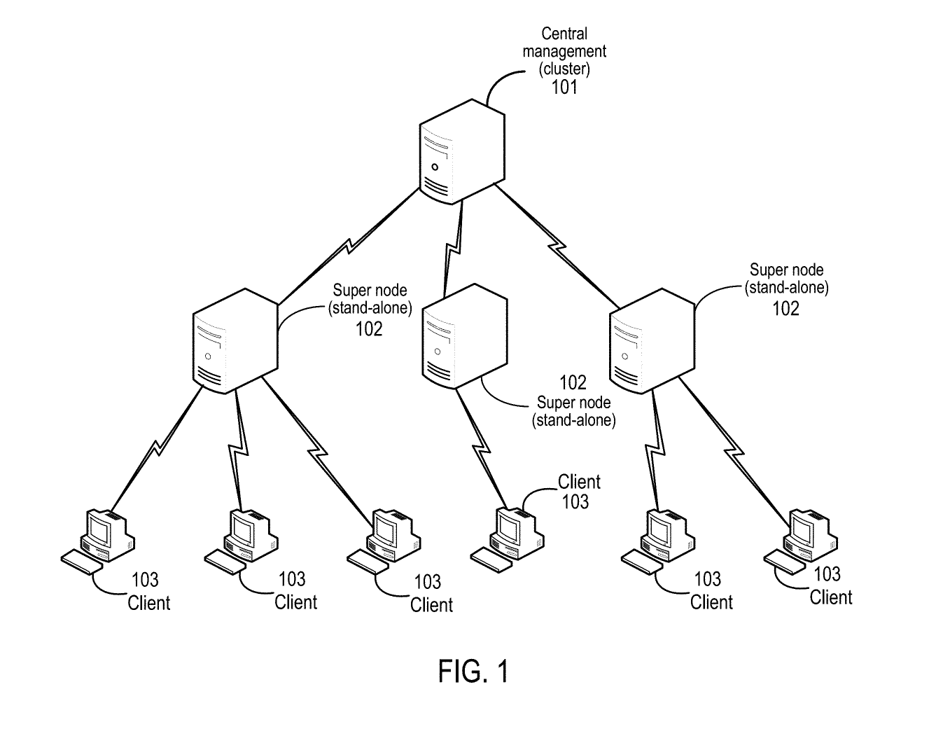

FIG. 1 is a block diagram illustrating an exemplary scenario of a P2P distribution system in actual application of some embodiments of the disclosure.

The P2P distribution system may include a control node (101) (which may be deployed in a cluster), supernodes (102) (which may be deployed in stand-alone form), and various clients (103) deployed on application hosts. The P2P distribution system can be used for providing layers of a Docker image to the clients (103). Specifically, each layer can be downloaded to any client in slice form from a supernode (102) or from other clients.

Specifically, the control node (101) can be used for scheduling each client (103) to an optimal supernode (102) for registration. Meanwhile, the control node (101) can distribute a download policy and perform configuration management on the P2P distribution system shown in FIG. 1. The download policy may include: the number of retries due to a download failure of the client (103); the number of tasks concurrently processed by the client (103); and a policy about how to perform downloading from a source station when the supernode (102) does not save a layer or slices thereof. The number of retries due to a download failure is the maximum number of times downloading may be initiated again when the client (103) fails in downloading slices of a layer of a Docker image from another client or a supernode. The number of tasks concurrently processed by the client (103) is the maximum number of slices that can be simultaneously downloaded when the client downloads slices. Moreover, the configuration management on the P2P distribution system may include uplink and downlink network speed limit of the supernode (102), the processing capacity of the supernode, P2P clients capable of downloading Docker images, and the like.

The supernodes (102) are all deployed stand-alone without being related to one another, and thus obviating synchronization overheads caused by distributed concurrent processing. The supernodes (102) do not rely on any external services, and all processing is completely based on the local memory, achieving extremely high processing performance in nanoseconds. A supernode (102) is mainly responsible for downloading a layer of a Docker image from a source station (the address where the layer is saved in a Docker repository), performing information management on clients, performing P2P network maintenance, and providing a download service of slices of the layer for various clients (103).

The client (103) may be installed on each application host, and has the primary function of requesting the download of a layer of a Docker image and performing uploading and downloading of slices of the layer, i.e., P2P downloading between clients, according to a scheduling result of the supernode (102).

Based on the system illustrated in FIG. 1, the clients (103) can download Docker image files from one another in a P2P mode.

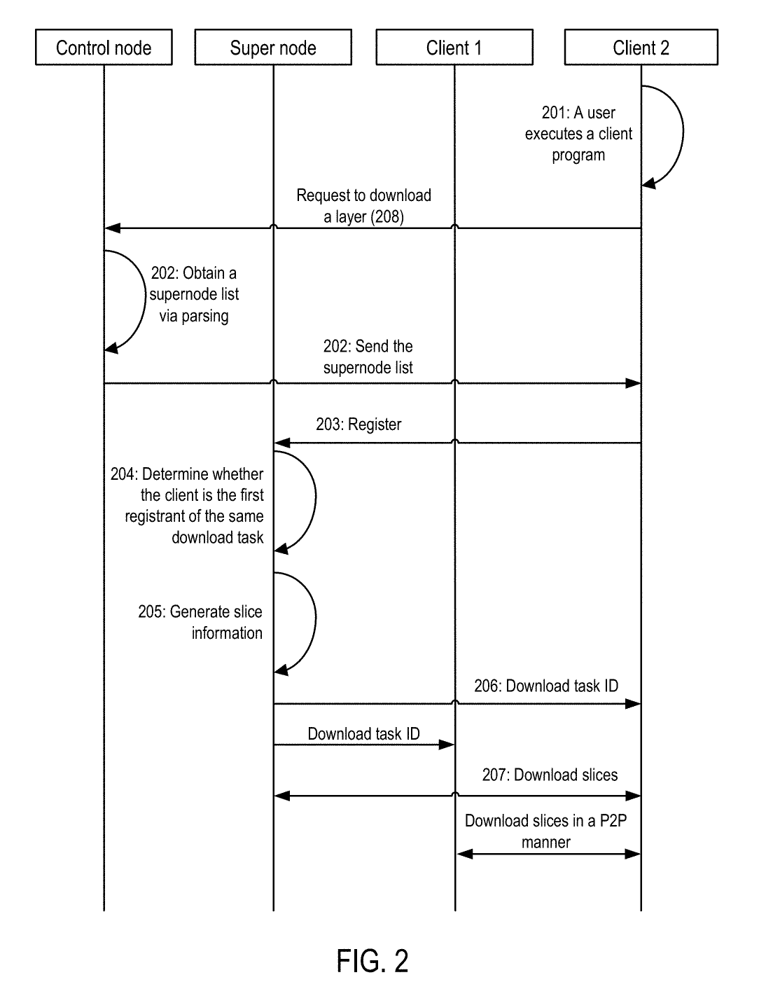

FIG. 2 is a swimlane interaction diagram of a P2P downloading procedure of the P2P distribution system shown in FIG. 1 according to some embodiments of the disclosure.

Step 201: A user first executes a client program through a command line or a command channel (e.g., SSH).

In this step, when the user executes the client program through a command line or a command channel, parameters included therein must contain a source station address, the source station address representing a location of an original file needing to be downloaded by the user. The source station address may be an HTTP source or may be, in an extended manner, an HDFS source, a Git source, an FTP source, or other types of sources. After the user executes the client program, the client (103) sends a scheduling service request to the control node (101) for a layer 1 scheduling service (request 208).

Step 202: The control node obtains, by parsing, a supernode list according to location information of the client and the load status of each supernode. The method then returns the supernode list to the client.

After receiving the scheduling service request from the client, the control node obtains, by parsing, a supernode list available to the client according to location information of a client node where the client is located and the load status of each supernode (102). Available supernodes may be ranked according to priorities in the supernode list. Specifically, the priority may be determined according to the load status of each supernode. For example, a supernode with the smallest load has the highest priority, etc. The location information of the client may also be considered. For example, a supernode with the smallest load within a preset distance from the client has the highest priority, etc. The specific manner of determining the priority is not limited in the disclosure.

Step 203: The client registers with an optimal supernode in the supernode list. The optimal supernode initializes corresponding client information and downloads progress information after receiving a registration request.

After receiving the supernode list, the client registers with a supernode having the highest priority in the supernode list. After receiving the registration request, the optimal (highest priority) supernode immediately initializes information of the client node where the client is located and downloads progress information of a file to be downloaded by the client.

Step 204: The optimal supernode determines whether the client is the first registrant of the same download task. If so, the flow enters step 205. If not, the flow enters step 206.

The optimal supernode further determines whether the client is the first registrant of the entire download task after initializing the client information. If the client is the first registrant of the entire download task, the flow enters step 205. In actual application, a URL of the same source station address corresponds to the same download task, the same download task generally contains multiple clients, and the multiple clients constitute a P2P network.

Step 205: The optimal supernode generates slice information and the flow enters step 206.

In this embodiment, the optimal supernode further generates slice information that may include slice content of a layer of a Docker image and a slice number and an MD5 check code of each slice.

Step 206: The client receives a download task ID sent by the supernode, and requests slice information from the optimal supernode through the download task ID.

After a successful registration of the client, the optimal supernode sends a download task ID to the client. The download task ID is used for uniquely identifying a current download task of the client and a layer is downloaded between the client and the supernode through the download task ID.

Step 207: After receiving the slice information sent by the optimal supernode, the client downloads specified slices from a target node specified by the optimal supernode, the target node including the optimal supernode and/or other clients.

After the optimal supernode sends the slice information to the client, the optimal supernode notifies the client of a target node at the same time. That is, the optimal supernode informs the client whether slices needing to be downloaded should be downloaded from the optimal supernode or from other clients that have downloaded the slices.

The target node may be the optimal supernode itself; in this case, a download mode of the client is a C/S mode. The target node may also be other clients; in this case, the download mode between the clients is a P2P mode.

After completing downloading a certain slice, the client may report a result that downloading of the slice is completed to the optimal supernode and again acquire slice information of a subsequent slice to be downloaded. The client repeats this process (reporting a download result of a downloaded slice, acquiring slice information of a subsequent slice to be downloaded, and so on) until all slices of the layer are completely downloaded.

A normal downloading process is described above. For abnormalities, the P2P distribution system also performs some compensation processing. In this case, for example, when a client A fails in downloading a certain slice from another client B (possibly because the client B exits abnormally), the client A sends the download failure to the optimal supernode. The optimal supernode re-determines a target node according to the situation of other clients that have downloaded the slice and schedules the client A to the re-determined target node to download the slice.

Additionally, if the request of the client to the optimal supernode is abnormal (possibly because the supernode breaks down), the client performs a dynamic migration. Specifically, the client re-registers with a new supernode (that may be selected from the supernode list according to the priority order) and continues downloading the slice that is not completely downloaded in a resumable manner.

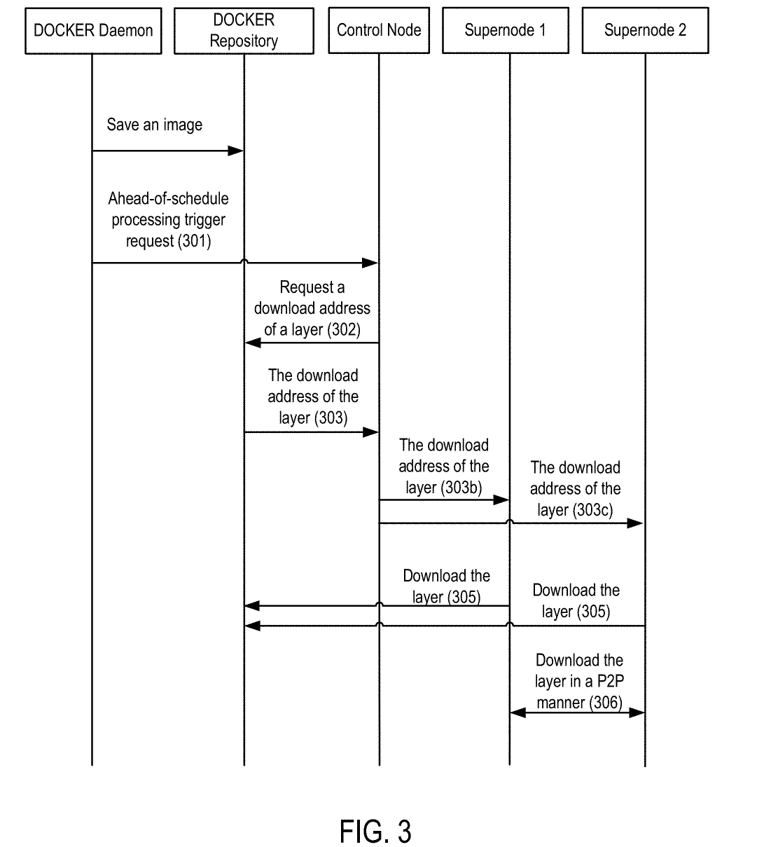

FIG. 3 is a flow diagram illustrating a method of downloading a Docker image ahead of schedule according to some embodiments of the disclosure. This embodiment may include the following step 301 to step 306.

Step 301: A Docker client (e.g., Docker daemon) triggers a downloading ahead of schedule request for a layer of a Docker image to a control node after each push of a layer of an image.

In this embodiment of the disclosure, downloading ahead of schedule refers to the in-advance downloading of a layer of a Docker image saved in a Docker repository to a supernode after completing building the layer (Docker build). The specific supernodes to which the layer is downloaded are related to the application to be deployed. For the application to be deployed, computer rooms to which the application needs to be deployed may be determined first, and then supernodes associated with these computer rooms are the supernodes that need to perform the downloading ahead of schedule processing.

Specifically, the downloading ahead of schedule processing on a layer level refers to the following: each time a layer of Docker image is saved (pushed) into a Docker repository after Docker build is completed, synchronization of the corresponding layer to a supernode is immediately triggering. The Docker push process is layer by layer in series; the synchronization process of the layer is to perform downloading in parallel in a P2P mode between various supernodes that need to perform the downloading ahead of schedule processing. In this manner, the layer can be downloaded in advance to supernodes in some areas according to needs, thereby effectively solving the problem of excessively slow long-distance image downloading.

It should be noted that the downloading ahead of schedule process is performed asynchronously and does not affect the original push operation of the other layers of the Docker image of the Docker. A communication address of the control node may be configured in the form of a command line parameter upon startup of the Docker daemon.

Step 302: The control node sends to a Docker repository a download request for a layer of a Docker image after receiving a triggered downloading ahead of schedule request for the layer sent by a Docker client.

In this embodiment, before the control node triggers a downloading ahead of schedule processing for a supernode, the control node acquires a download address of a corresponding layer from a Docker repository according to an image name, an image tag, and a digest of a layer of a Docker image. In actual application, each application has a Docker repository. Docker image files of the application are saved in the Docker repository. A Docker image file can be determined according to an image name and an image tag. A layer of the Docker image file can be found according to a digest of the layer.

Specifically, the Docker registry determines whether the control node passes authorization. If so, a download address of a layer is extracted according to a location field of an HTTP source station address response header included when a command line is configured by the user. If the authorization is not passed, an authorized URL may be generated according to a WWW-Authenticate field of the HTTP response header. The control node requests the authorized URL and adds user authentication information into the HTTP header to acquire an authorized token. Then, the control node requests authorization from the Docker registry.

Step 303: The control node receives a download address of the layer sent by the Docker repository (303a); and sends the download address of the layer to a supernode performing the downloading ahead of schedule processing (303b, 303c).

The Docker registry sends a download address of the layer to the control node. After the control node receives the download address, the control node sends the download address of the layer to a supernode performing the downloading ahead of schedule processing, to trigger the supernode performing the downloading ahead of schedule processing downloads the layer to a local storage according to the download address of the layer.

Step 304 (not illustrated): The supernode determines whether the layer is cached locally according to the download address of the layer. If not, the flow enters step 305. If so, the downloading ahead of schedule processing is performed successfully.

Step 305: Perform a downloading ahead of schedule processing on the layer and download the layer to local storage according to the download address of the layer and generate layer information of the layer, the layer information comprising an identifier and a check code of the downloaded layer.

After receiving the download address of the layer, the supernode determines whether the layer has been cached locally according to the layer corresponding to the download address. If not, the supernode may form a P2P network with all supernodes (306) needing to perform the downloading ahead of schedule processing on the layer. These supernodes download the layer from each other in a P2P manner. The supernode then generates a corresponding meta-information file after the layer is completely downloaded. The meta-information file may include a layer identifier of the layer for cache location, or may further include an MD5 value of the layer for judging validity of the layer.

After the supernode successfully performs the downloading ahead of schedule processing or during the downloading ahead of schedule processing of the supernode, if the supernode receives a request for downloading a layer that is sent by a P2P client, the supernode may further include the following steps A1 step A3.

Step A1: After the supernode receives a download request for a layer that is sent by the P2P client and that includes a source station address of the layer, the supernode determines whether the layer to be downloaded is cached. If so, the flow enters step A2. If not, the flow enters step A3.

In actual applications, the P2P client may download a certain layer after the supernode has performed the downloading ahead of schedule processing, or the P2P client downloads a certain layer when the supernode has not performed the downloading ahead of schedule processing successfully. Then, after the supernode receives a download request for a layer that is sent by the P2P client and that includes a source station address of the layer, the supernode first determines whether the layer to be downloaded has been cached locally.

Step A2: Generate respective slice information for each slice, the slice information comprising a slice identifier and a corresponding slice check code and respectively send to the client each slice with slice information generated.

If the layer to be downloaded by the P2P client is cached locally, the supernode generates slice information of each slice of the layer, such as a slice identifier and a corresponding slice check code (an MD5 value or the like), so that the client downloads the slice according to the slice information.

Step A3: Download slices of the layer from a source station to the local storage according to the source station address, and generate respective slice information for each downloaded slice, the slice information comprising a slice identifier and a corresponding slice check code; and respectively send to the P2P client each slice with slice information generated.

In this embodiment, each time the supernode downloads a slice from the source station, the supernode can generate slice information of the slice, and can provide the slice to the client for downloading after generating the slice information.

It can be seen that in this embodiment of the disclosure, each time a layer of a Docker image is saved (successfully pushed) into a Docker repository, a downloading ahead of schedule procedure on a supernode can be triggered. That is, the supernode separately synchronizes each layer of the Docker image from the Docker repository to the local storage first; and after the synchronization, a client downloads the Docker image from the supernode subsequently, so that the supernode can directly provide the Docker image or trigger other clients to provide the Docker image, thereby improving the efficiency of Docker image downloading. Further, even if the supernode does not save a Docker image needing to be downloaded by the client, the Docker image can be downloaded from the Docker repository in real time and be provided to the client, to avoid a direct interaction between the client and the Docker repository and ensure the stability of Docker image downloading.

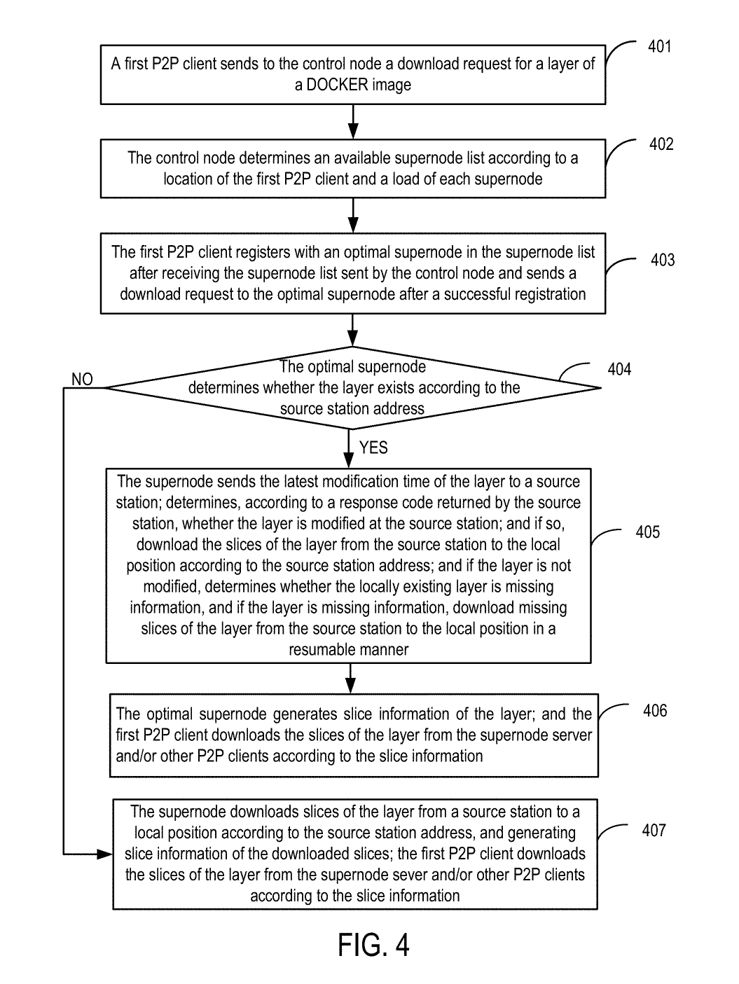

FIG. 4 is a flow diagram illustrating method of downloading a Docker image according to some embodiments of the disclosure.

This embodiment may be applied to a P2P distribution system, and the P2P distribution system may include a control node, supernodes, and P2P clients. This embodiment may include the following steps.

Step 401: A first P2P client sends a download request for a layer of a Docker image (e.g., a container image) to a control node.

In this embodiment, a manifest file of the Docker image includes a digest (signed with SHA-256) for each layer in the entire Docker image. A Docker daemon analyzes and compares existing layers locally according to the manifest file to determine a layer not cached locally as a layer to be downloaded. For the layer needing to be downloaded, the Docker daemon requests a download address of the layer to be downloaded from a Docker registry and invokes a P2P client to download the layer.

Specifically, a current client sending a download request comprising a first P2P client is used as an example. The first P2P client sends a download request for a layer of a Docker image to the control node first.

Step 402: The control node determines an available supernode list according to a location of the first P2P client and a load of each supernode.

The control node determines an available supernode list according to a location of the first P2P client and a load of each supernode and sends the supernode list to the first P2P client.

Step 403: The first P2P client registers with an optimal supernode in the supernode list after receiving the supernode list sent by the control node and sends a download request to the optimal supernode after a successful registration, the download request optionally including a source station address of the layer of the Docker image.

The source station address is the address where the layer of the Docker image is saved in a Docker repository.

Step 404: The optimal supernode determines whether the layer exists according to the source station address. If so, the method proceeds to step 405. If not, the method proceeds to step 407.

The optimal supernode first determines whether it has cached the layer according to the source station address. If the layer is cached, it indicates a cache hit, and each slice of the layer can be separately provided to the client for downloading. If the layer is not cached, back-to-source synchronization needs to be performed. That is, the layer is downloaded from the Docker repository and provided to the client.

Step 405: The supernode sends the latest modification time of the layer to a source station; determines, according to a response code returned by the source station, whether the layer is modified at the source station. If so, the method downloads the slices of the layer from the source station to local storage according to the source station address. If the layer is not modified, the method determines whether the locally existing layer is missing information. If the layer is missing information, the method downloads missing slices of the layer from the source station to the local storage in a resumable manner.

In the case that the layer is cached, the supernode may send a HyperText Transfer Protocol (HTTP) HEAD request including an ‘If-Modified-Since’ field to a source station. The value of the field is the last modification time of the layer that is returned during last access to the source station. If the HTTP response code returned by the source station is 304, it represents that the layer in the source station has currently not been modified, which indicates that the layer originally cached in the supernode is valid. Then the method may further determine whether the layer cached in the supernode is missing information. If the layer is missing information, the missing part of slices also needs to be downloaded from the source station in a resumable manner. If the layer is not missing information, the downloading does not need to be continued. However, if the layer in the source station is modified, the HTTP response code is 200, which indicates that the layer cached in the supernode is invalid. Then back-to-source synchronization needs to be performed. That is, the layer is downloaded from the source station again.

In either case, the optimal supernode will finally cache the layer needing to be downloaded by the client, and then the flow enters step 406.

Step 406: The optimal supernode generates slice information of the layer and the first P2P client downloads the slices of the layer from the supernode server and/or other P2P clients according to the slice information.

The optimal supernode generates slice information of the layer that has been cached, and the slice information may include slice numbers and corresponding MD5 check codes. The slice numbers may be used by a client for identifying slices downloaded by the client and the MD5 check codes are used for slice integrity check when clients transmit slices to one another.

Step 407: The supernode downloads slices of the layer from a source station to local storage according to the source station address and generates slice information of the downloaded slices. The first P2P client downloads the slices of the layer from the supernode sever and/or other P2P clients according to the slice information.

If the supernode has not cached the layer needing to be downloaded by the client, the supernode then downloads the layer from a source station according to the source station address and generates slice information of downloaded slices. Each time the supernode generates slice information of a slice, the supernode can immediately provide the slice to the client for downloading. Then multiple clients downloading the slice can form a P2P network, to rapidly download the slice to the local storage.

In actual applications, if the first P2P client downloads a slice A from a second P2P client, if the second P2P client is abnormal (such as the second P2P client exiting abnormally) the first P2P client fails in downloading the slice A. In this case, the following steps C1 to C3 may be performed.

Step C1: The first P2P client determines whether downloading of a slice from the second P2P client is successful. If not, the flow enters step C2.

The first P2P client downloading the slice A determines whether downloading from the second P2P client is successful. If the downloading is unsuccessful, the subsequent step C2 is performed. If the downloading is successful, the subsequent step C2 is not performed.

Step C2: The first P2P client sends information of the slice not downloaded successfully and the corresponding second P2P client to the optimal supernode, so that the optimal supernode allocates another third P2P client that can download the slice A normally for the first P2P client.

Step C3: The first P2P client downloads the slice A from the third P2P client.

The first P2P client can re-download the slice A from the third P2P client.

Another scenario that may exist in actual application is that the first P2P client downloads a slice B from the supernode. If the supernode is abnormal, like the supernode breaks down, the first P2P client would also fail in downloading the slice B. In this case, the following steps D1 to D3 may be performed.

Step D1: The first P2P client determines whether downloading of a slice from the optimal supernode is successful. If not, the flow enters step D2.

The first P2P client determines whether downloading of the slice B from the optimal supernode is successful. For example, the determination may be performed through an MD5 check code of the slice B. If the downloading is unsuccessful, the subsequent step D2 is performed. If the downloading is successful, the subsequent step is not performed.

Step D2: The first P2P client registers with the next supernode according to a priority of each available supernode in the supernode list until re-registration is successful.

The first P2P client registers with the next supernode according to a priority of each supernode in the supernode list. If the registration from the first P2P client is successful, the first P2P client continues downloading the slice B from the next supernode in a resumable manner. If the registration from the first P2P client is not successful, the first P2P client continues to register with the next supernode according to the priority order until the registration is successful.

Step D3: The first P2P client downloads the slice from the re-registered supernode in a resumable manner.

The first P2P client downloads the slice B from the re-registered supernode in a resumable manner.

In this embodiment, a control node, supernodes, and a P2P client on an application host are separately deployed. When an application needs to be released to the application host, the P2P client sends a download request to the control node. The control node allocates an optimal supernode and other clients to the client, so that a Docker image is downloaded from the supernode directly, or multiple clients needing to download the same Docker image download the Docker image from each other in a P2P manner. In this way, the client does not need to directly interact with a Docker repository, which not only improves the efficiency of Docker image downloading and then accelerates the entire process of using Docker to deploy an application. The method also ensures stability in the downloading process.

Moreover, the embodiments of the disclosure are completely transparent to a user in that the user only needs to execute a Docker download command on a client to pull a Docker image as usual. That is, the P2P distribution system in the embodiments of the disclosure can be directly used to download the Docker image to achieve the effect of accelerating downloading. Therefore, the embodiments of the disclosure not only can solve the problem concerning the efficiency of large-scale image distribution, but also can solve, to a large extent, the problem that long-distance image downloading is slow or even fails due to timeout.

An embodiment of the disclosure further provides a data transmission method, which can be used for transmitting target data between a sending end and a receiving end. The target data may include at least first-granularity sub-data, and the first-granularity sub-data may include at least second-granularity sub-data. The data transmission method may specifically include the following steps.

Step E1: The sending end decomposes the target data into multiple pieces of first-granularity sub-data.

In this embodiment, target data is saved in the sending end, and the sending end may first decompose the target data into multiple pieces of first-granularity sub-data when sending the target data to multiple receiving ends. For example, the data needing to be sent by the sending end is K, and the data includes a total of five pieces of sub-data, for example, K1, K2, K3, K4, and K5 respectively.

Step E2: The sending end sends the multiple pieces of first-granularity sub-data to multiple broker devices respectively.

In this embodiment, multiple broker devices may be disposed between the sending end and the multiple receiving ends. For example, the sending end needs to send target data to ten receiving ends, and five broker devices are disposed between the ten receiving ends and the sending end.

Correspondingly, when sending the multiple pieces of first-granularity sub-data to multiple broker devices respectively, the sending end may first acquire a preset correspondence between the first-granularity sub-data and the broker devices then send the multiple pieces of first-granularity sub-data to the multiple broker devices respectively according to the correspondence. For example, the correspondence preset in the sending end is that the first-granularity sub-data K1 is sent to the broker device 1. The second-granularity sub-data K2 is sent to the broker device 2 and so on. The fifth-granularity sub-data K5 is sent to the broker device 5. Certainly, this is merely an exemplary setting. The sending end may further select some of the broker devices for sending first-granularity sub-data or different broker devices may correspond to different pieces of first-granularity sub-data, and so on.

Assuming that each broker device receives first-granularity sub-data sent from the sending end, and each broker device then downloads, from other broker devices to a local storage, first-granularity sub-data not sent by the sending end to each of the broker device. That is, the first-granularity sub-data can be sent among the broker devices. For example, the broker device 1 receives the first-granularity sub-data K1. The broker device 1 downloads the second-granularity sub-data K2 from the broker device 2. As another example, the broker device 1 downloads the fifth-granularity sub-data K5 from the broker device 5.

Certainly, when another correspondence exists between the first-granularity sub-data and the broker devices, each broker device only needs to separately download the missing part of its first-granularity sub-data from other broker devices having this part of first-granularity sub-data to the local storage.

Step E3: The broker devices decompose the first-granularity sub-data into multiple pieces of second-granularity sub-data.

After the broker devices receive the complete target data including all the first-granularity sub-data, the broker devices separately decompose each piece of first-granularity sub-data into multiple pieces of second-granularity sub-data. For example, the broker device 1 decomposes the first-granularity sub-data K1 into three pieces of second-granularity sub-data: K11, K12, and K13 then decomposes the second-granularity sub-data K2 into two pieces of second-granularity sub-data: K21 and K22, and so on.

Specifically, how each broker device decomposes each piece of first-granularity sub-data received by the broker device may be set according to the content of the first-granularity sub-data, the number of the sending ends, and the like, which can be decided by those skilled in the art.

Step E4: The broker devices send the multiple pieces of second-granularity sub-data to the multiple receiving ends.

In this step, the broker devices then send to the multiple receiving ends the multiple pieces of second-granularity sub-data after decomposition. Specifically, the broker devices may also respectively send to the multiple receiving ends the multiple pieces of second-granularity sub-data according to a preset correspondence between the second-granularity sub-data and the receiving ends; and each receiving end receives a part of second-granularity sub-data; and each receiving end then separately downloads, from other receiving ends to the local storage, second-granularity sub-data not sent by the broker device to each of the receiving end. Reference may be made to the introduction of step E3 for the specific sending manner, which will not be described herein again.

To describe the foregoing method embodiments briefly, all the method embodiments are expressed as a combination of a series of actions, but those skilled in the art should know that the disclosure is not limited by the sequence of the described actions because certain steps can adopt other sequences or can be included out at the same time according to the disclosure. Secondly, those skilled in the art should also know that all the embodiments described in the specification belong to exemplary embodiments; the related actions and modules are not necessarily needed for the disclosure.

An embodiment of the disclosure further provides a peer-to-peer (P2P) client, wherein the P2P client may be deployed in a P2P distribution system, and the P2P distribution system may include a control node, supernodes, and P2P clients. The P2P client may specifically include: a first sending unit, configured to send a request for downloading a layer of a Docker image to the control node, so that the control node determines an available supernode list according to a location of the first P2P client and a load of each supernode; a requesting unit, configured to request downloading of the layer from an optimal supernode in the supernode list, so that the optimal supernode generates slice information of each slice of the layer; the slice information comprising a slice identifier and a corresponding slice check code; and a first downloading unit, configured to download slices of the layer from the optimal supernode and/or the other P2P clients to a local storage according to the slice information.

If the P2P client fails in downloading a slice from the optimal supernode, the P2P client may further include: a first determination unit, configured to determine whether downloading of slices from the optimal supernode is successful; a registration unit, configured to do the following: in the case that a result of the first determination unit is negative, register with a next supernode according to a priority of each supernode in the supernode list until re-registration is successful; and a second downloading unit, configured to download the slices from the re-registered supernode in a resumable manner.

If the first P2P client fails in downloading a slice from a second P2P client, the P2P client may further include: a second determination unit, configured to determine whether downloading of slices from a second P2P client is successful; a second sending unit, configured to do the following: in the case that a result of the second determination unit is negative, send information of the slices not downloaded successfully and the corresponding second P2P client to the optimal supernode, so that the optimal supernode allocates a third P2P client for the first P2P client; and a third downloading unit, configured to download the slices from the third P2P client.

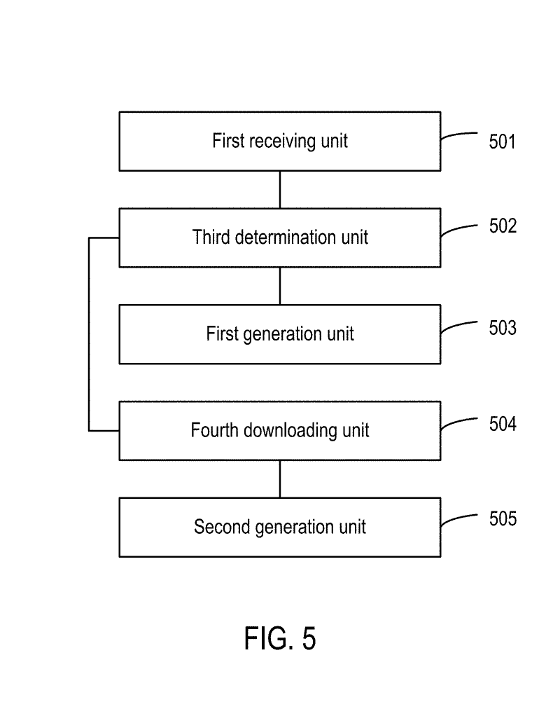

FIG. 5 is a functional block diagram illustrating an exemplary structure of a supernode according to some embodiments of the disclosure.

In this embodiment, the supernode may be deployed in a P2P distribution system, and the P2P distribution system includes a control node, the supernode, and P2P clients. The supernode may include: a first receiving unit 501, configured to receive a download request of a first P2P client, the download request comprising a source station address of a layer of a Docker image; a third determination unit 502, configured to determine whether a layer exists according to the source station address; a first generation unit 503, configured to do the following: in the case that a result of the third determination unit is that the layer exists, generate slice information of the layer, the slice information comprising slice identifiers and corresponding slice check codes; the first P2P client is then enabled to download slices of the layer from the supernode server and/or other P2P clients according to the slice information; a fourth downloading unit 504, configured to do the following: in the case that the result of the third determination unit is that the layer does not exist, download slices of the layer from a source station to a local storage according to the source station address; and a second generation unit 505, configured to generate slice information of the slices downloaded by the downloading unit, so that the first P2P client downloads the slices of the layer from the supernode and/or other P2P clients according to the slice information.

The supernode may further include: a third sending unit, configured to send to the source station the latest modification time of the layer; a fourth determination unit, configured to determine, according to a response code returned by the source station, whether the layer is modified at the source station; a fifth downloading unit, configured to do the following: in the case that the result of the determination unit is that the layer exists, download slices of the layer from a source station to the local storage according to the source station address; a fifth determination unit, configured to do the following: in the case that the result of the determination unit is negative, determine whether the locally existing layer is missing information; and a sixth downloading unit, configured to do the following: in the case that a result of the determination unit is that the layer is missing information, download slices missing in the layer from the source station to the local storage in a resumable manner.

An embodiment of the disclosure further provides a P2P distribution system. The P2P distribution system may specifically include a control node, supernodes, and P2P clients, wherein the P2P client is configured to send to the control node a download request for a layer of a Docker image; the P2P client requests an optimal supernode in the supernode list to download the layer; the control node is configured to determine an available supernode list according to a location of the P2P client and a load of each supernode, and sending the supernode list to the P2P client. The supernode is configured to determine whether the layer exists according to a source station address in the download request of the first P2P client. If so, generate slice information of the layer; the P2P client is then enabled to download slices of the layer from the supernode server and/or other P2P clients according to the slice information. If the layer does not exist, download slices of the layer from a source station to a local storage according to the source station address, and generate slice information of the downloaded slices, so that the P2P client downloads the slices of the layer from the supernode sever and/or other P2P clients according to the slice information.

An embodiment of the disclosure further provides a control node, wherein the control node may be deployed in a peer-to-peer (P2P) distribution system, and the P2P distribution system may specifically include the control node, supernodes, and P2P clients. The control node may specifically include: a fourth sending unit, configured to send to a Docker repository a download request for a layer of a Docker image after receiving a triggered downloading ahead of schedule request for the layer sent by a Docker client; a second receiving unit, configured to receive a download address of the layer sent by the Docker repository; and a fifth sending unit, configured to send the download address of the layer to a supernode performing the downloading ahead of schedule processing, so that the supernode performing the downloading ahead of schedule processing downloads the layer to a local storage according to the download address of the layer.

An embodiment of the disclosure further provides a supernode, wherein the supernode is deployed in a peer-to-peer (P2P) distribution system, and the P2P distribution system may specifically include a control node, the supernode, and P2P clients. The supernode may specifically include: a third receiving unit, configured to receive a download address of a layer of a Docker image sent by the control node; a sixth determination unit, configured to determine whether the layer is cached locally according to the download address of the layer; and a downloading ahead of schedule unit, configured to do the following: in the case that a result of the determination unit is negative, perform a downloading ahead of schedule processing on the layer and download the layer to a local storage according to the download address of the layer and generate layer information of the layer, the layer information comprising an identifier and a check code of the downloaded layer.

The supernode may further include: a seventh determination unit, configured to determine whether a layer to be downloaded is cached after receiving a download request for the layer sent by the P2P client, the download request comprising a source station address of the layer; a third generation unit, configured to do the following: in the case that a result of the determination unit is that the layer is cached, generate respective slice information for each slice, the slice information comprising a slice identifier and a corresponding slice check code; and respectively send to the client each slice with slice information generated; and a seventh downloading unit, configured to do the following: in the case that the result of the determination unit is that the layer is not, download slices of the layer from a source station to the local storage according to the source station address, and generating respective slice information for each downloaded slice, the slice information comprising a slice identifier and a corresponding slice check code; and respectively sending to the P2P client each slice with slice information generated.

It should be noted that each embodiment in the disclosure is described in a progressive manner, with each embodiment focusing on parts different from one another; and reference can be made to each other for identical and similar parts among various embodiments. With regard to the device embodiments, since the device embodiments are similar to the method embodiments, the description is relatively concise; and reference can be made to the description of the method embodiments for related parts.

Finally, it should also be noted that relational terms such as first and second are used herein only to distinguish one entity or operation from another entity or operation without necessarily requiring or implying that these are the actual relations or orders between the entities or operations. Furthermore, the terms “comprising,” “including,” or any other variation thereof are intended to encompass a non-exclusive inclusion so that a process, method, article, or apparatus that includes a series of elements includes not only those elements but also other elements not explicitly listed, or elements that are inherent to such a process, method, article, or apparatus. The element defined by the statement “including one . . . ”, without further limitation, does not preclude the presence of additional identical elements in the process, method, article, or apparatus that includes the element.

A method for downloading Docker images and node and a method for downloading Docker images ahead of schedule and node provided in the disclosure are introduced in detail above. The principles and implementation manners of the disclosure are set forth herein with reference to specific examples, and descriptions of the above embodiments are merely served to assist in understanding the method and essential ideas of the disclosure; and to those of ordinary skill in the art, changes may be made to specific implementation manners and application scopes according to the ideas of the disclosure. In view of the above, the contents of the specification should not be construed as limiting the disclosure.

1. A method comprising:
receiving, by a supernode from a client device, a download request for a layer of a container image file, the supernode selected from a supernode list comprising a plurality of supernodes;
generating, by the supernode, slice information of each slice of the layer; and
transmitting, by the supernode, the slice information and at least one target node to the client device, the transmitting of the slice information and the target node causing the client device to initiate a download of slices from the supernode to the at least one target node.

2. The method of claim 1, further comprising:
receiving, at a control node, the download request;
obtaining, by the control node, the supernode list based on location information of the client device and load statuses of the plurality of supernodes; and
transmitting, by the control node, the supernode list to the client device, the transmitting of the supernode list causing the client device to register with an optimal supernode in the supernode list by transmitting a registration request to the optimal supernode.

3. The method of claim 2, the obtaining a supernode list further comprising ranking the supernodes based on the load statuses, the ranking comprising one or more of ranking the supernodes based on the load statuses and ranking the supernodes based on a distance of the supernodes from the location of the client device.

4. The method of claim 1, the generating slice information comprising generating, by the supernode, slice content of a layer of a container image, a corresponding slice number and a corresponding MD5 check code of the layer.

5. The method of claim 1, the transmitting the at least one target node to the client device comprising transmitting, by the supernode, an identifier of the supernode.

6. The method of claim 1, further comprising:
receiving, at the supernode, a result of downloading of a slice from the client device; and
transmitting, by the supernode, second slice information to the client device.

7. The method of claim 1, further comprising:
receiving, at the supernode, a download failure of a failed slice from the client device; and
transmitting, by the supernode, a new target node to the client device, the new target node comprising a device that has previously downloaded the failed slice.

8. The method of claim 1, the download request further comprising a source station address of the layer of the container image file.

9. The method of claim 1, further comprising:
determining, by the supernode, whether the layer exists according to a source station address of the layer;
generating, by the supernode, the slice information of the layer if the layer exists; and
downloading, by the supernode, slices of the layer from a source station to local storage according to the source station address and generating slice information of the downloaded slices if the layer does not exist.

10. The method of claim 9, further comprising:
sending, by the supernode, to the source station the latest modification time of the layer if the layer exists;
determining, by the supernode and according to a response code returned by the source station, whether the source station modified the layer and, if the layer is modified, downloading the slices of the layer from the source station to the local storage according to the source station address; and
if the layer is not modified, determining, by the supernode whether the locally existing layer is missing information, and if the layer is missing information, downloading missing slices of the layer from the source station to the local storage in a resumable manner.

11. The method of claim 1, each item of slice information comprising a slice identifier and a corresponding slice check code.

12. A supernode comprising:
a processor; and
a storage medium for tangibly storing thereon program logic for execution by the processor, the stored program logic comprising:
logic executed by the processor for receiving, from a client device, a download request for a layer of a container image file, the supernode selected from a supernode list comprising a plurality of supernodes;
logic executed by the processor for generating slice information of each slice of the layer; and
logic executed by the processor for transmitting the slice information and at least one target node to the client device, the transmitting of the slice information and the target node causing the client device to initiate a download of slices from the supernode to the at least one target node.

13. The apparatus of claim 12, the logic for generating slice information comprising logic executed by a processor for generating slice content of a layer of a container image, a corresponding slice number and a corresponding MD5 check code of the layer.

14. The apparatus of claim 12, the logic transmitting the at least one target node to the client device comprising logic executed by a processor for transmitting an identifier of the supernode.

15. The apparatus of claim 12, the logic further comprising:
logic executed by a processor for receiving a result of downloading of a slice from the client device; and
logic executed by a processor for transmitting second slice information to the client device.

16. The apparatus of claim 12, the logic further comprising:
logic executed by a processor for receiving a download failure of a failed slice from the client device; and
logic executed by a processor for transmitting a new target node to the client device, the new target node comprising a device that has previously downloaded the failed slice.

17. The apparatus of claim 12, the download request further comprising a source station address of the layer of the container image file;

18. The apparatus of claim 12, the logic further comprising:
logic executed by a processor for determining whether the layer exists according to a source station address of the layer;
logic executed by a processor for generating, by the supernode, the slice information of the layer if the layer exists; and
logic executed by a processor for downloading slices of the layer from a source station to local storage according to the source station address and generating slice information of the downloaded slices if the layer does not exist.

19. A method comprising:
receiving, by a supernode, a download address of a layer of a container image sent by the control node;
determining, by the supernode, whether the layer is cached locally according to the download address of the layer;
downloading, by the supernode, the layer to a local position according to the download address of the layer if the layer is not cached locally; and
generating, by the supernode, layer information of the layer.

20. The method according to claim 19, further comprising:
determining, by the supernode, whether a layer to be downloaded is cached after receiving a download request for the layer sent by a client device, the download request comprising a source station address of the layer;
generating, by the supernode, slice information of each slice if the layer is cached, the slice information comprising a slice identifier and a corresponding slice check code; and
sending, by the supernode to the client device, each slice with slice information generated.

21. The method of claim 20, further comprising:
downloading, by the supernode, slices of the layer from a source station to the local position according to the source station address if the layer is not cached; and
generating, by the supernode, respective slice information for each downloaded slice, the slice information comprising a slice identifier and a corresponding slice check code.
